(19) United States
(12) Patent Application Publication
(10) Pub. No.: US 2018/0066199 A1
(43) Pub. Date: Mar. 8, 2018

(54) Method and system for the manufacture of methane as well as heat and electricity by hydrogasification of biomass

(71) Applicant: BICARBO SP.Z.O.O., Warszawa (PL)

(72) Inventors: Adam Krylowicz, Zamosc (PL); Jaroslaw Krylowicz, Warszawa (PL)

(21) Appl. No.: 15/556,943

(22) PCT Filed: Mar. 10, 2016
(86) PCT No.: PCT/IB2016/051373

§ 371 Date: Sep. 8, 2017

(30) Foreign Application Priority Data
Mar. 12, 2015 (PL) P.411560

(51) Int. Cl. C10L 3/08; C10L 9/08; C10J 3/72; C10J 3/62; C10J 3/48; C01B 3/38

(52) U.S. Cl. CPC C10L 3/08; C10L 9/08; C10J 3/723; C10J 3/721; C10J 3/62; C10J 3/482; C01B 2203/1241; C10J 2300/0966; C10J 2300/1815; C01B 2203/065; C01B 2203/0833; C01B 2203/1058; C01B 3/388

(57) ABSTRACT

The method for the manufacture of bio-methane and eco-methane as well as electric and thermal energy according to the present invention consists in hydrogasification of a mixture of bio-carbon and fossil carbon in a carbon hydrogasification reactor using bio-hydrogen obtained in a bio-hydrogen production reactor from a mixture of bio-methane and steam in the presence of a catalyst and with a CO₂ acceptor being a mixture of magnesium and calcium oxides. The raw gas formed, after purification, is subjected to separation into hydrogen and methane sent to a hydrogen production process and to feed a power generation unit. Spent CO₂ acceptor is subjected to calcination and the CO₂ produced in the calcination process is directed to a CO₂ sequestration process. The system for the manufacture of methane and energy consists of a first reactor (1) for the hydrogasification of a mixture of bio-carbon and carbon prepared by a carbon feed preparation unit (25) connected to a biomass pyrolysis apparatus (22) and a carbon conveyor (24) and fed by a carbon mixture conveyor (26) to the first reactor (1) connected to a vapour and gas separator (15), said separator having a hydrogen outlet connected to the first reactor (1) and a methane outlet connected to a third reactor (3) and the power generation unit (5). Additionally, the third reactor (3) has a CO₂ acceptor inlet connected to a second reactor (2) for the calcination of the spent CO₂ acceptor and a spent CO₂ outlet at the third reactor (3) connected via a conveyor (14) to the second reactor (2). A CO₂ pipeline (10c) is connected to a CO₂ sequestration system, whereas another CO₂ pipeline (10d) for the regenerating CO₂ stream exiting the second reactor (2) is connected via a heat exchanger (8) and a preheater (9) of that stream, connected via a pipeline (10) to the second reactor (2).

The subject of the present invention is a method for the manufacture of bio-methane and eco-methane by hydrogasification of bio-carbon and fossil carbon where bio-hydrogen is the gasification agent, as well as a method for the manufacture of electricity and heat.

Bio-methane is a product of hydrogasification of bio-carbon using bio-hydrogen. The product of hydrogasification of coal or lignite using bio-hydrogen is eco-methane. Bio-carbon is a product of pyrolysis of dry biomass preferably with high content of cellulose, hemicellulose and lignin. Another favourable pyrolysis product is steam and flammable gases-hereinafter referred to as the pyrolytic gas. The product of an incomplete pyrolysis of biomass at 170° C.-270° C. is semi-carbon which contains approximately 60%-65% elemental carbon C′ with chemical properties similar to those of lignite. The product of a complete pyrolysis of biomass at temperature higher than 270° C., preferably at 300° C., is bio-carbon which contains approximately 65%-80% elemental carbon C′ with chemical properties similar to those of coal or coke.

Known from the book by Jerzy Szuba, Lech Michalik, entitled: “Karbochemia”, “Silesia” publishing house, 1983, methods for hydrogasification using hydrogen obtained mostly by steam-and-oxygen based gasification of fine coke or coal.

Known from that book is the HYGAS method developed at the Institute of Gas Technology (USA). The HYGAS method is a process of high pressure hydrogasification of coal combined with gasification of fine coke, which makes it possible to obtain a high thermal value gas (substitute for natural gas). There are three tested versions of that process, differing in the method of producing hydrogen for hydrogasification. Hydrogen is obtained either by oxygen-steam coal gasification or electrothermal gasification or as a result of oxidation-reduction of iron oxides with gas obtained from gasification of fine coke (steam-iron system).

Known from that book is the Hydrane method developed by the Pittsburgh Energy Research Center (USA). The Hydrane method consists in obtaining a high thermal value gas by direct reaction of coal with hydrogen. Coal feedstock (any grade) reacts with hydrogen contained in a hot gas. The gasification process occurs at 815° C. Coal gasification occurs in a co-current, falling and thinned bed suspended in an internal reactor. Fine coke thus produced precipitates to a fluidized bed in an external reactor, to undergo further reaction with hydrogen. The internal and external reactors form a single device. Hydrogen for the process is obtained in a separate reactor by steam-oxygen gasification of a part of fine coke.

Known from the patent specification US 2011/0126458A1 is a method for the production of gaseous fuel rich in methane through a combination of hydrogasification of a coal feedstock with hydrogen and steam. Gasification is carried out on an aqueous slurry of coal using hydrogen and superheated steam in a temperature range of approximately 700° C.-1000° C. and at a pressure of approximately 132 kPa to 560 kPa. The product of such gasification is hydrogen, methane, carbon monoxide and carbon dioxide. Hydrogen is separated from this mixture in a separator and recycled back to the SHR carbon gasifier also fed with steam, and a mixture of CH₄, CO and CO₂ is a fuel gas rich in methane (up to 40% of CH₄).

From the Chinese patent specification CN1608972A there is known a method for the production of hydrogen in a biomass gasification process using steam mixed with a CO₂ acceptor in the form of a mixture of calcium oxide and magnesium oxide which exhibits catalytic properties in biomass gasification. The resulting mixture of magnesium and calcium carbonates and unreacted fine coke, separated from ash in a cyclone, is fed to a carbonates calcination reactor, where it undergoes calcination by combustion of fine coke in an air stream fed at the bottom of the carbonates calcination reactor, wherefrom a regenerated CO₂ acceptor being a mixture of calcium and magnesium oxides (CaO/MgO) is recycled back to the biomass gasification reactor.

All these methane manufacturing processes feature large consumption of elemental carbon (C)—for producing two molecules of CH₄ at least 5 elemental carbon atoms (C) are consumed. This limits the efficiency of the carbon hydrogasification processes. It is characterized by high CO₂ emissions to atmosphere and an increased emission of solid waste to the environment.

The present invention solves the issue of application of plant-based raw materials from cultivated crops and organic waste and full utilisation of biomass having high content of cellulose, hemicellulose and lignin to produce bio-methane and bio-carbon, and, subsequently, bio-hydrogen for hydrogasification of bio-carbon to bio-methane and fossil carbon to eco-methane and high-efficiency conversion, exceeding 60%, of the chemical energy of the resulting fuel to electricity. These effects have been obtained by producing bio-carbon in a biomass pyrolysis process, forming a mixture of bio-carbon with fossil carbon, and gasification of said mixture using bio-hydrogen obtained using bio-methane, steam and a novel CO₂ acceptor which is regenerated using thermal energy from a power generation unit, from pyrolytic gas combustion, and using solar energy, which leads to its accumulation.

The method for the manufacture of bio-methane and eco-methane as well as electricity and thermal energy using a process of pyrolysing biomass to biocarbon mixed with comminuted and, possibly, appropriately prepared fossil carbon and using a process of hydrogasification of the carbon mixture to raw gas, its desulphurisation and separation into hydrogen and methane using a process of producing hydrogen in a reaction of methane with steam and with a CO₂ acceptor and regeneration of the acceptor and with the use of MCFC fuel cells and a gas-steam power and heat plant to produce electricity and heat, is characterized in that a comminuted dry plant-based material or a waste-based raw material is subjected, individually or in specified sets, to a pyrolysis process, either in the temperature range of approximately 170° C.-270° C. at normal pressure to produce semi-carbon and a pyrolytic gas or in the temperature range of approximately 270° C.-300° C. to produce bio-carbon and a pyrolytic gas or in the temperature range higher than 300° C., with a part of the pyrolytic gas directed to carry out pyrolysis of biomass in a biomass pyrolysis apparatus, and the other part of pyrolytic gas is directed to pre-heat the regenerating stream of CO₂ in the preheater. The resulting semi-carbon, containing around 60%-65% of elemental carbon, is mixed preferably with comminuted lignite, while bio-carbon containing approximately 65%-80% of elemental carbon is mixed with comminuted coal in a ratio of elemental carbon C′ from bio-carbon to elemental carbon C from fossil carbon preferably being C′:C=1:1. This mixture is fed to a first low-pressure or high-pressure hydrogasification reactor where a process of complete hydrogasification is carried out using bio-hydrogen to produce raw gas and ash, or a process of incomplete hydrogasification to produce raw gas and fine coke. The fine coke is partly discharged to a fine coke storage facility and partly fed to pre-heat the CO₂ regenerating stream in the preheater and burned. The raw gas obtained is fed to a process of separating vapours and gases, where it is dried and subjected to desulphurisation, and then separated into hydrogen, residual gases, and a methane mixture consisting of pure bio-methane and eco-methane. A part of the methane, after cooling down in a heat exchanger, is directed to supply a power generation unit, from which heat is fed to a heat exchanger to heat a regenerating CO₂ stream and to a heat exchanger in the waste heat boiler that produces process steam and power steam, and the other part of the cooled down methane is fed either to a compressor or to a condenser or introduced to a gas distribution pipeline. Hot bio-methane at a temperature approximately 800° C. is fed to a third bio-hydrogen generation reactor where, in a reaction of bio-methane with hot steam supplied from the waste heat boiler and with the use of a CO₂ acceptor bio-hydrogen is produced which, after cooling down, is directed to the process of hydrogasification of a carbon mixture in the first reactor, while spent CO₂ acceptor in the form of a mixture of carbonates of magnesium and calcium is directed to a second reactor for calcination using hot regenerating CO₂ stream. The regenerated CO₂ acceptor in the form of magnesium oxide and calcium oxide is fed to the third reactor, and the CO₂ stream at a temperature of approximately 400° C. leaving the second reactor is supplied in a first part to the heat exchanger in the waste heat boiler where it is cooled down. After cooling, it is directed either to a known CO₂ sequestration process, or to compression and solidification of CO₂ to form dry ice, or discharged to the atmosphere. The other part, as the regenerating CO₂ stream, is heated to a temperature of about 700° C. needed for the calcination of magnesium carbonate, or to a temperature of about 1000-1100° C. needed for the calcination of a mixture of magnesium and calcium carbonates, and also in a preheater supplied periodically with a hot heat carrier heated in a solar collector to a temperature of 1100-1200° C., and the regenerating CO₂ stream so heated is fed to a second reactor.

A comminuted dry mixture of semi-carbon with lignite or bio-carbon with coal, after removing the air from it by using CO₂, is supplied from a carbon mixture preparation unit to the first low pressure reactor. In the first reactor, there occurs the process of hydrogasification of the carbon mixture, first in the internal chamber in a suspended bed falling in co-current with a gas introduced at the top of the internal chamber, said gas containing approximately 50% of H₂ and 50% of CH₄ at a temperature about 815° C. at normal pressure. The raw gas obtained in this process is passed from the first reactor into a separator of vapours and gases, where it is cleaned from dust and admixed gases and, in particular, is subjected to desulphurisation, after which it is separated into a pure methane mixture consisting of bio-methane and eco-methane, and into pure hydrogen recycled back to the bio-hydrogen stream. A partly reacted carbon mixture is fed to an external chamber in the first reactor, where it is made to completely react with hydrogen to produce ash and hydrogen-and-methane gas, or to partially react to form fine coke and hydrogen-and-methane gas. The ash is discharged to storage and the fine coke is fed either to combustion or to a storage facility, while the hydrogen-and-methane gas is top-fed to the inner chamber of the reactor.

In the first high pressure reactor, the carbon mixture after combining with mineral oil is fed in the form of a suspension, using a spray nozzle, to the topmost section of the reactor, called the evaporation section, at a pressure of about 6.8 MPa. At the temperature prevailing there, approximately 315° C., the oil evaporates and its vapours are discharged together with a hot raw gas leaving the middle section, called the first stage of hydrogasification, to the vapour and gas separator. The separated mineral oil, then liquefied in a condenser, is recycled to the carbon suspension in oil preparation unit, and purified raw gas, especially after desulphurisation, is separated into a methane mixture and pure hydrogen combined with bio-hydrogen. Dry carbon and bio-carbon particles at a temperature of about 300° C. are directed to the central section, subjected to fluidization in a stream of biohydrogen-containing gas leaving the reactor bottom section called the second stage of carbon hydrogasfication, and in the central section, at a temperature elevated to approximately 650° C. and at a pressure of 6.0 MPa degassing and partial hydrogasification of carbon particles takes place. Partly reacted carbon mixture is subjected to complete hydrogasification in a fluidal bed in the bottom reactor section at a temperature of 750-950° C. using bio-hydrogen fed to that section.

As the CO₂ acceptor that participates in the bio-hydrogen manufacturing process magnesium oxide is used, or, preferably, a mixture of magnesium oxide with calcium oxide at a preferable ratio MgO:CaO=1:3 molar quantities of the substance needed for the reaction to produce bio-hydrogen with amount of heat around 155 kJ/mol-165 kJ/mol of CH₄ at more than 100° C. during continuous operation of the third reactor, depending, however, on the amount of heat brought into the reactor by these reactants; thus, this proportion is adjustable in the range of 1:10 to 10:1.

For the process of thermal decomposition of carbonates involving solar power, CO₂ acceptor and contributing energy to the bio-hydrogen generation reaction, it is preferred to use calcium oxide, whose energy of CO₂ uptake, 178.8 kJ/mol, contributed to the bio-hydrogen manufacturing process is about 45% of the energy of burning one mole of elemental carbon.

In the second shaft reactor, in a bed of carbonates of magnesium and calcium fluidised by a hot stream of CO₂ at about 1100° C., in the bottom zone of the reactor thermal decomposition of calcium carbonate is carried out in the temperature range around 1000° C.-800° C., and in the upper zone of the reactor thermal decomposition of magnesium carbonate is carried out in the range of approximately 800° C.-400° C., producing oxides of magnesium and calcium and carbon dioxide.

The power generation unit consumes eco-methane which is supplied to the gas turbine and a fuel cell, and the heat from the fuel cell, at a temperature of approximately 650° C., is directed to a heat exchanger to heat the regenerating CO₂ stream, and flue gas exiting the fuel cell, at a temperature of approximately 400° C., is supplied to a heat exchanger in the waste heat boiler.

Flue gases from the last stage of the gas turbine, at a temperature preferably about 700° C., are supplied to the heat exchanger to heat the regenerating CO₂ stream, and the flue gas exiting the outlet at a temperature of 400° C.-600° C. is fed to a heat exchanger in the waste heat boiler, wherefrom power steam at about 585° C. is fed to the steam turbine of a steam turbine unit.

The waste heat boiler receives heat from the energy production unit through the approx. 400° C.-600° C. flue gases, heat from the approx. 400° C. CO₂ stream leaving the second magnesium and/or calcium carbonates calcination reactor, heat from the approx. 500° C. stream of hot bio-hydrogen and from the approx. 800° C. stream of hot eco-methane produced in the first carbon hydrogasification reactor.

The regenerating CO₂ stream receives heat from a heat carrier heated up to approx. 1100-1200° C. by solar energy.

The heat carrier heated by solar energy is a gas which is inert with respect to the materials used in the solar concentrators unit, preferably carbon dioxide or nitrogen or argon, or a gas with high specific heat, preferably helium, or a vapour which is inert with respect to those materials, preferably water vapour or a liquid with a high boiling point.

Bio-methane, steam and CO₂ acceptor as the reactants producing bio-hydrogen in the presence of a Ni/Al₂O₃ nickel catalyst in the range 500° C.-900° C. and at a pressure of 1.5 MPa-4.5 MPa in the first part of the third reactor in the reactor tubes are additionally heated by hot CO₂ stream having temperature of about 800° C.-1000° C.—especially during the start-up of the third reactor.

For the bio-hydrogen producing reaction in the third reactor, of carbon monoxide and water vapour with a mixture of gases flowing in from the first part to the second part of that reactor, occurring at a lower temperature range than that in the first part, either a Cu—Zn/Al₂O₃ catalyst is used in the range of approximately 200° C.-300° C. or an Fe/Al₂O₃ catalyst in a higher temperature range of 350° C.-500° C. followed by a Cu/Al₂O₃ catalyst in the range of approx. 200° C.-300° C.

Another subject of the present invention is a system for the manufacture of bio-methane and eco-methane as well as heat and electricity. The system for the manufacture of bio-methane and eco-methane as well as heat and electricity, consisting of a carbon hydrogasification reactor, a reactor for calcination of carbonates of magnesium and calcium, a reactor for the production of bio-hydrogen, a vapour-gas separator, an apparatus for biomass pyrolysis, a carbon mixture feed preparation unit, a waste heat boiler possibly connected to a CO₂ sequestration subsystem, an energy production unit, a preheater for the regenerating CO₂ stream, heat exchangers, conveyors, pumps, and pipelines for liquids, vapours and gases, is characterized in that the first carbon hydrogasification reactor having an inlet connected via a carbon mixture/carbon suspension conveyor to a carbon mixture/carbon suspension feed preparation unit that is connected to a biomass pyrolysis apparatus and a coal or lignite conveyor, and also the first reactor having an outlet for fine coke or ash and an outlet for raw gas from the first reactor has a connection to a vapour-gas separator which has an outlet for dusts, vapours and residual gases and a residual hydrogen outlet in the form of a pipeline connected to the bio-hydrogen outlet from a third reactor, said outlet being in the form of a pipeline connected to the first hydrogasification reactor. The vapour-gas separator also has an outlet for bio-methane and eco-methane in the form of a pipeline connected to the third bio-hydrogen production reactor and to an power generation unit. The flue gas outlet at the power generation unit, in the form of a pipeline, is, connected to the waste heat boiler which has a process steam outlet connected to the third bio-hydrogen production reactor and a power steam outlet connected to the steam turbine the power generation unit, and also a CO₂ inlet connected to a CO₂ outlet at a second carbonate calcination reactor, said reactor also having a regenerating CO₂ inlet in the form of a pipeline, said inlet connected to a preheater of that stream, and a CO₂ acceptor outlet connected via an acceptor conveyor to that acceptor's inlet at the third bio-hydrogen production reactor and the outlet of spent acceptor at the third reactor is connected via a spent acceptor conveyor to the second reactor for the calcination of spent CO₂ acceptor in the form of calcium and magnesium carbonates.

The biomass pyrolysis apparatus has a dry biomass inlet connected to a biomass conveyor and a bio-carbon outlet connected to a bio-carbon conveyor which feeds the carbon mixture preparation unit. The pyrolytic gas outlet at the biomass pyrolysis apparatus is connected to a gas burner disposed in the biomass pyrolysis apparatus and to a gas burner disposed in the regenerating CO₂ stream preheater.

The first low pressure carbon hydrogasification reactor comprises two chambers: an internal chamber for the hydrogasification of the carbon mixture and an external chamber for the hydrogasification of fine coke. It has a thermally insulated shell through which passes an inlet channel of the carbon mixture feed coming from the mixture preparation unit having a CO₂ inlet connected to a CO₂ pipeline, connected to a CO₂ pipeline for processing, and a gas outlet. The internal chamber of the first reactor has inlets for the primary gas from the external chamber and an outlet for the raw gas, and at the bottom, an outlet for partly converted carbon mixture fed to the external chamber, which also has a hydrogen inlet.

The second reactor, shaped as a shaft furnace, has at its bottom a CO₂ acceptor feeder connected via an acceptor conveyor an acceptor inlet at the third bio-hydrogen production reactor, said reactor having an outlet for spent CO₂ acceptor connected via a spent acceptor conveyor to an inlet at the second magnesium and calcium carbonates calcination reactor. The second reactor is equipped with at least one regenerating CO₂ stream nozzle located at the bottom and connected to the regenerating CO₂ stream preheater, additionally, the second reactor has at the top a CO₂ outlet connected to a CO₂ inlet at the waste heat boiler.

The preheater of the regenerating CO₂ stream is equipped with a heat exchanger, which is connected to a heat exchanger in the power generation unit, and is also equipped with a gas burner connected to the pyrolytic gas pipeline and with a pulverized fuel burner, connected to a fine coke conveyor from the first reactor and/or coal or bio-carbon conveyor. Additionally, the preheater has a heat exchanger connected to a solar collector unit through the outlet of the heat carrier to a heat exchanger placed in the focal point of each concave mirror and the inlet of that carrier. The heat exchanger in the power generation unit has at the inlet a connection to a CO₂ stream pipeline, and at the outlet a connection to the heat exchanger in the preheater. The CO₂ regenerating stream outlet at the heat exchanger in the preheater is connected to the inlet at the second carbonate calcination reactor—with a nozzle or a nozzle system located in the bottom of the reactor, said CO₂ stream outlet also having a connection to the third reactor to heat the reactor tubes. The power and heat generation unit has an electric connection to a power grid, and a connection via a heat pipeline to a heating network.

The power generation unit, consisting of a fuel cell and a gas-steam power and heat plant, is connected to the unit's collector heat exchanger, whereas the fuel cell has a heat exchanger connected via heat pipelines to the collector heat exchanger. The outlet of the fuel cell is connected via a heat pipeline to the waste heat boiler. Flue gas outlet at the methane combustion chamber is connected to the gas turbine and the gas turbine flue gas outlet is connected to a heat exchanger located in the collector heat exchanger and, further, to the waste heat boiler. The waste heat boiler is connected to the third bio-hydrogen production reactor via a process steam pipeline and to the steam turbine of the steam turbine unit via a power steam pipeline and, additionally, a CO₂ pipeline runs through the collector heat exchanger of the power generation unit, said pipeline having a heat exchanger connected to the heat exchanger in the preheater.

In addition, the waste heat boiler has an inlet for water and an inlet for CO₂ from the second carbonate calcination reactor, said inlets connected through the heat exchanger in the boiler to a CO₂ outlet for processing or discharging to the atmosphere and/or to a CO₂ outlet for sequestration and, additionally, the waste heat boiler has an inlet for the heat carrier from the hydrogen, methane and fuel cell flue gas cooling processes.

The third bio-hydrogen production reactor has internal tubes containing a nickel catalyst supported on a ceramic substrate Ni/Al₂O₃ located in the first part of the third reactor, said first part connected to a hot CO₂ stream heating these tubes, as well as tubes containing either a Cu—Zn/Al₂O₃ catalyst or an Fe/Al₂O₃ and Cu/Al₂O₃ catalyst, said tubes located in the second part of the third bio-hydrogen production reactor, whereas the third reactor has an inlet for bio-methane, an inlet for process steam and an inlet for CO₂ acceptor, as well as an outlet for magnesium and calcium carbonates and an outlet for bio-hydrogen.

The power generation unit for small objects consists of either a fuel cell and/or a co-generator.

The methane pipeline that supplies methane to the power generation unit has a connection in the form of a pipeline to either a gas distribution pipeline or a methane compressor and to a CNG tank or a methane condenser and an LNG tank.

An advantage of the method of producing bio-methane and eco-methane according to the present invention is the use of bio-carbon from biomass renewable on a yearly basis to produce bio-methane and to transfer heat to the bio-hydrogen production reaction through the new CO₂ acceptor in the form of magnesium and calcium oxides, said acceptor making it possible to control the heat, and the regeneration heat is available from the power generation unit, from pyrolytic gas combustion, and from solar energy, which allows for low consumption of elemental carbon C from fossil carbon and to convert it with steam to eco-methane—to produce one molecule of CH₄ at most one carbon atom (C) of fossil carbon is consumed. This significantly reduces CO₂ emission and carbon-related solid waste emissions into the environment. It significantly reduces the consumption of fossil carbon in the manufacture of the gaseous fuel: bio-methane or eco-methane. This fuel allows generating electricity in the power generation unit with energy efficiency exceeding 60%.

The advantage is the simultaneous hydrogasification of bio-carbon and fossil carbon in one reactor using bio-hydrogen. Hydrogasification of carbon is an exothermic process; it does not need heat to be supplied to the reaction, therefore heat exchangers in the hydrogasification reactor are not necessary. Formed in the CO₂ uptake reaction, magnesium carbonate is easily calcined at about 550° C. using heat supplied from a source of electricity and heat, which greatly increases the efficiency of the system. The mixture of calcium and magnesium carbonates requires a higher calcination temperature, approx. 900° C. The appropriately higher temperature is achieved in the regenerating CO₂ stream by using a gas burner and a pulverized fuel burner. The temperature of the CO₂ stream, up to 1200° C., is achieved in the solar collector unit, thus creating a new method of using solar energy—it its accumulated in the regenerated CO₂ acceptor, especially in the calcium-based CO₂ acceptor, and then in the gaseous fuel produced, namely bio-methane and eco-methane. The efficiency of the production of electricity from solar energy is at the level of 48%. Currently, the efficiency of photovoltaic cells is approximately 15%. The pure CO₂ stream obtained in the process of calcination of the spent CO₂ acceptor is easy to incorporate in a CO₂ sequestration process, whether under the ground or by binding CO₂ to silicates to form stable products. This leads to emission-free generation of electricity using fossil carbon for this purpose.

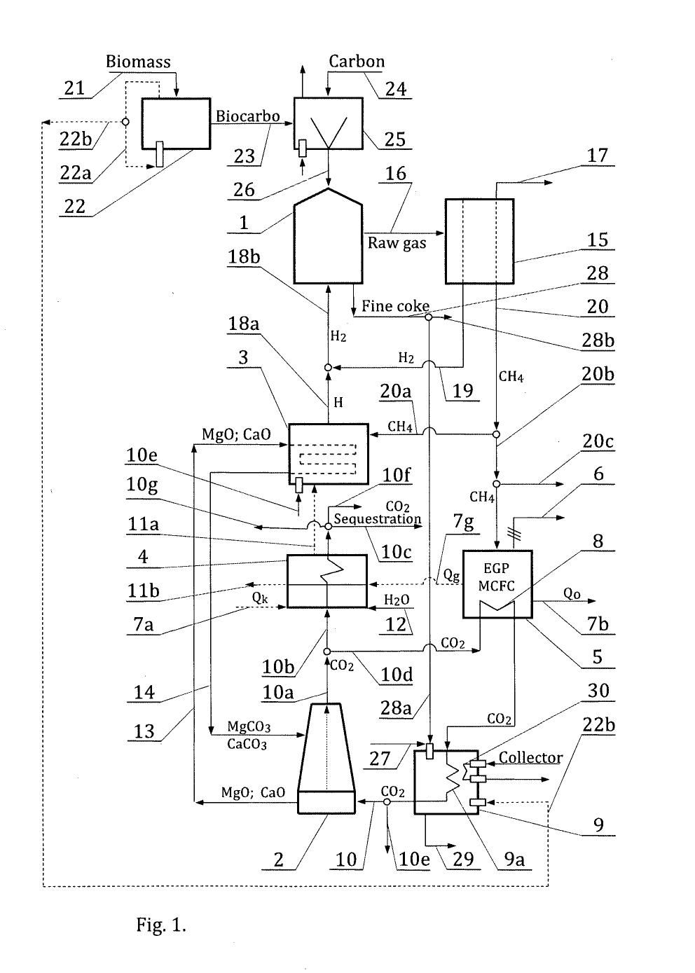

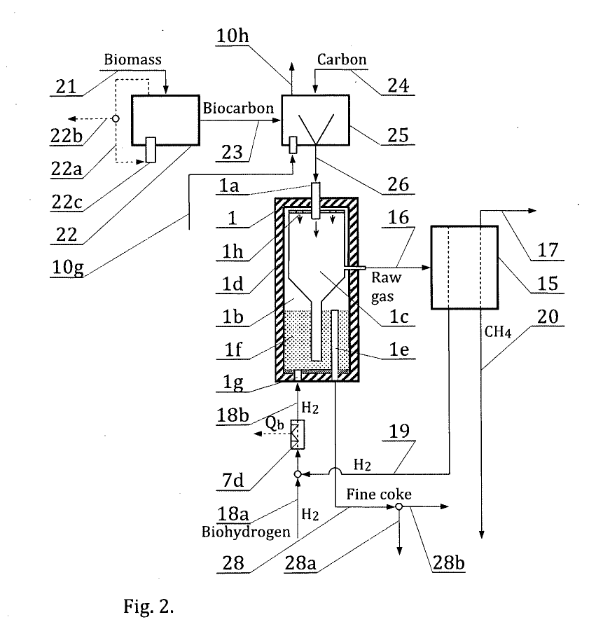

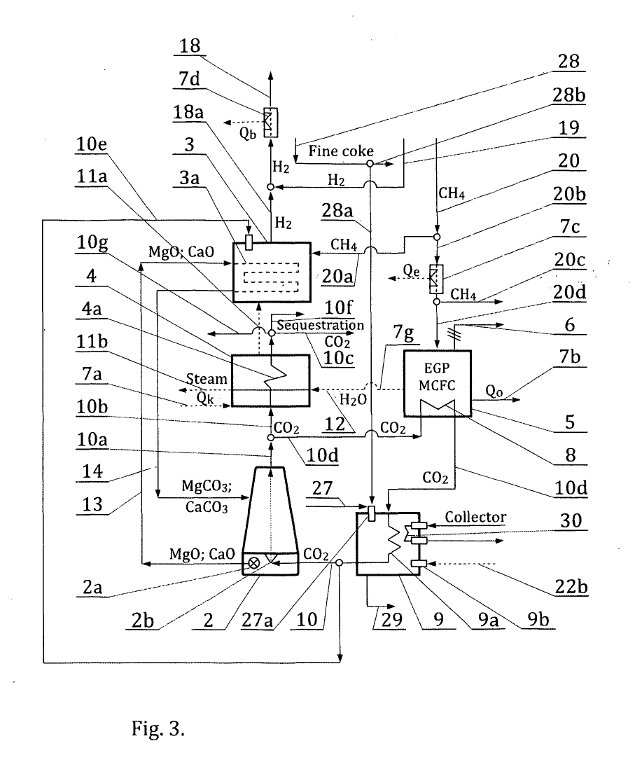

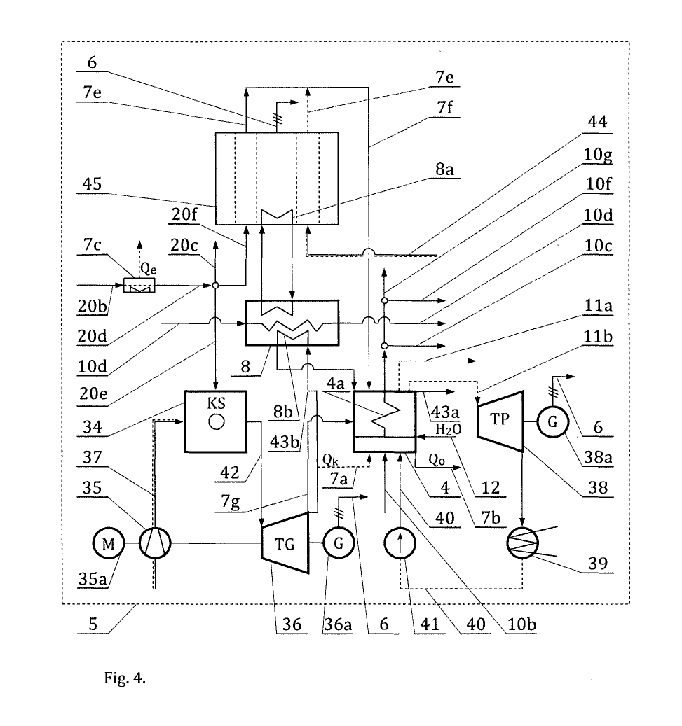

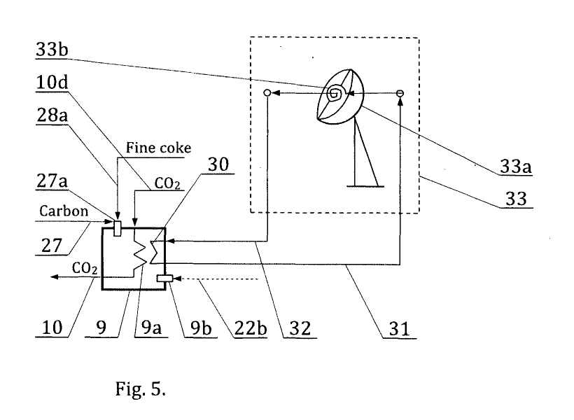

The subject of the present invention is illustrated in an example embodiment in the drawings in which FIG. 1 shows a diagram of the technological process, which illustrates the connections between the subsystems and the equipment used in the process of producing bio-methane and eco-methane as well as heat and electricity, FIG. 2 shows a diagram of a sub-system for the manufacture of bio-methane and eco-methane using the first carbon hydrogasification reactor, FIG. 3 shows the connections of the second reactor for the calcination of magnesium carbonate or a mixture of calcium and magnesium carbonates with the waste heat boiler and with the third bio-hydrogen generation reactor and with the power and heat generation unit and with the regenerating CO₂ stream heater, FIG. 4 depicts the power generation unit combined with a high temperature fuel cell and with a gas-steam power and heat plant, FIG. 5 shows a solar collector unit connected with the regenerating CO₂ stream.

### EXAMPLE I

Bio-carbon with elemental carbon content C′ of 77% and coal having elemental carbon content of 70-80% were fed to the bio-carbon and fossil carbon hydrogasification process, keeping pre-set bio-carbon to coal ratio of C′:C=1:1. In the first bio-carbon and fossil carbon hydrogasification reactor 1 shown in FIG. 2 there is carried out a complete conversion of bio-carbon and fossil carbon using bio-hydrogen. The system for the production of bio-methane and eco-methane as well as power and thermal energy is depicted in FIG. 1, and the power generation unit is shown in FIG. 4. It is a gas-steam heat and power plant with electric power capacity Pₑₛ, coupled with a fuel cell unit with total electric power capacity P_{ew}, preferably 7% of Pₑₛ. The fuel cell unit 45 is used to start-up the system and to generate electricity for captive use. As the biomass for the full pyrolysis process carried out in a biomass pyrolysis apparatus 22 at about 300° C. dry wood chips were used, fed into the apparatus 22 using a biomass conveyor 21. The product of biomass pyrolysis is bio-carbon as well as vapours and combustible pyrolytic gas conveyed via a pipeline 22a to a gas burner 22c in the apparatus 22 and through a pipeline 22b to a gas burner 9b located in the preheater 9 of the regenerating CO₂ stream. The bio-carbon is conveyed from the apparatus 22, using a bio-carbon conveyor 23, to a carbon mixture preparation unit 25, where it is mixed and appropriately comminuted together with coal fed to the unit 25 through a conveyor 24. This mixture, without any special pre-treatment, is fed by a conveyor 26 to the top of the first carbon hydrogasification reactor 1 where it is hydrogasified to bio-methane and eco-methane at approx. 815° C. by bio-hydrogen coming from the third bio-hydrogen production reactor 3, said hydrogen being conveyed through a bio-hydrogen pipeline 18a and, after cooling in a heat exchanger 7d connected to a waste heat boiler 4, fed through a pipeline 18b to the bottom of the first reactor 1. Bio-hydrogen, by flowing through a fluidised bed 1f of a mixture of carbon with fine coke in the external chamber 1b of the first reactor 1, said chamber having a thermal insulation 1d, causes thermal fluidisation of that bed and reacts with bio-carbon and coal to produce a reactive gas that contains about 50% hydrogen and 50% methane, said gas flowing through holes 1h of the shell into the internal chamber 1c and, while flowing co-currently with the falling suspended bed of the carbon mixture it react with that mixture which is fed to the internal chamber using the carbon mixture conveyor 26 from the mixture preparation unit 25 through the mixture inlet 1a to the chamber 1c. As a result of the reaction of the reactive gas with coal and bio-carbon in the internal chamber 1c of the first reactor 1 there occurs a partial conversion of that mixture with bio-hydrogen, and the partially converted carbon mixture falls down to a fluidal bed 1f in the external chamber 1b where it is completely converted with bio-hydrogen and the resulting ash is discharged through an ash discharge channel 1e and transported with a conveyor 28b to an ash storage site, and the unconverted fine coke, possibly recovered on a sieve and by an air stream, is recycled back to the carbon mixture preparation unit 25. Raw gas from the first reactor is fed via a pipeline 16 to a vapour and gas separator 15. Raw gas (dry) has the following average composition: CH₄ approx 72% vol., H₂ approx. 15.3% vol., CO—1.5%, CO₂—approx. 1.6%, and other impurities, including H₂S, account for approx. 0.1%. In the gas and vapour separator 15 raw gas is desulphurised and separated on a membrane through which only hydrogen can flow, in a known way, recycled via the hydrogen pipeline 19 to the bio-hydrogen pipeline 18a. Vapours and residual gases are removed through pipeline 17, and the mixture of bio-methane and eco-methane flows through the pipeline 20 and is split into two equal streams—hot bio-methane fed via pipeline 20a to the third bio-hydrogen production reactor and eco-methane fed through pipeline 20b and cooled in the heat exchanger 7c connected via a heat pipeline to the waste heat boiler 4, then supplied through pipeline 20d to feed the power generation unit 5. Surplus eco-methane is supplied through pipeline 20c to a compressor which compresses eco-methane in a compressed eco-methane tank. The third bio-hydrogen production reactor 3 comprises tubes filled with a catalyst, i.e. nickel on a ceramic support. Hot bio-methane at a temperature of approx. 800° C. is fed to these tubes through the pipeline 20a, hot steam at a temperature of approx. 400° C. is fed through the steam pipeline 11a, and the CO₂ acceptor in the form of magnesium oxide is supplied by the CO₂ acceptor conveyor 13. As a result of the reaction that occurs in the third reactor 3 in tubes containing nickel catalyst, the reaction of the magnesium oxide (CO₂ acceptor) with bio-methane and water vapour leads to the formation of magnesium carbonate and bio-hydrogen supplied via bio-hydrogen pipelines 18a and 18b and heat exchanger 7d to the first reactor 1, while magnesium carbonate, the spent CO₂ acceptor, is supplied by a conveyor 14 to the second MgCO₃ calcination reactor 2. The uptake of CO₂ by MgO provides about 70% of the thermal energy required for this reaction, the remaining energy being brought about by hot bio-methane at approx. 815° C. and hot steam at 400° C. The heat evolving in the coal and bio-carbon hydrogasification reaction in the first reactor 1 is significantly higher than the heat needed to make up the thermal energy supplied to the bio-hydrogen production reaction. Excess heat is supplied to the waste heat boiler 4. In addition, thermal energy, especially during the start-up of the third reactor 3, can be supplied by a hot stream of CO₂ at a temperature of approximately 800° C. supplied by a pipeline 10e from the C02 stream preheater 9 and flowing around the tubes in the third reactor 3.

The bio-hydrogen production reaction takes place at a temperature of about 500° C. at appropriately increased pressure. Increasing the pressure to 3 MPa results in increased reaction speed, reduces the size of the third reactor 3 and increases the MgCO₃ thermal decomposition temperature, thereby boosting the operation of the CO₂ acceptor, and decreases reaction temperature. Heat from the heat exchangers 7c and 7d is supplied through heat pipelines, preferably the collector pipeline 7a, to the waste heat boiler 4, as well as from the hot stream of regenerating CO₂ at a temperature of about 400° C. supplied to the heat exchanger in the boiler by a CO₂ pipeline 10b. Most heat is supplied to the boiler by the power generation unit 5 through flue gas pipeline 7g. The waste heat boiler 4 is also supplied with make-up water from condensates and from an external source of water using a water pipeline 12. The waste heat boiler 4 produces process steam at about 400° C., which is supplied through a process steam pipeline 11a to the third bio-hydrogen production reactor 3, and power steam at a temperature of about 585° C. supplied via a power steam pipeline 11b to the power steam turbine 38 TP in the power generation unit 5.

The spent CO₂ acceptor in the form of magnesium carbonate is supplied from the third bio-hydrogen production reactor 3 using the spent CO₂ conveyor 14 and fed at the top of the second reactor 2, said reactor being shaft-shaped and intended for the calcination of magnesium carbonate. The regenerated CO₂ acceptor in the form of magnesium oxide is fed from the bottom of the second reactor 2 via a feeder 2a and a CO₂ acceptor conveyor 13 back to the third reactor 3. The calcination of magnesium carbonate occurs at a temperature of approx. 500° C.-550° C. in a falling fluidised bed inside the shaft reactor 2 using a hot stream of regenerating CO₂ at a temperature around 650° C.-700° C. entering the reactor through a nozzle 2b or a battery of nozzles located at the bottom of the second reactor 2. This stream, while passing through the fluidised bed of magnesium carbonate, causes its thermal decomposition and the regenerated magnesium oxide drops down along the reactor onto a feeder 2a, and the enriched CO₂ stream, cooled down at the exit of the second reactor 2 to about 400° C., enters the pipeline 10a, and then is split into two streams of CO₂—the first stream of regenerating CO₂ flows through pipeline 10d to heat exchanger 8 located in the power generation unit 5 where it is heated to about 650° C. by fuel cells 45 operating at a temperature of 650° C. and by a part of the blowdown exhaust flue gas at approximately 700° C. discharged from an extraction gas turbine 36 via a heat exchanger 8b and is fed to the waste heat boiler 4, and then the regenerating CO₂ stream at approx. 650° C. flows through a CO₂ pipeline to a regenerating CO₂ heat exchanger 9 where it is heated up to approx. 700° C. by a gas burner 9b supplied with pyrolytic gas fuel fed to the burner through the pipeline 22b and the regenerating CO₂ stream so heated is supplied through a CO₂ pipeline 10 to the nozzle or nozzle system 2b located at the bottom of the second magnesium carbonate calcination reactor 2.

When necessary, the heat exchanger 7c through which a hot stream of eco-methane flows at a temperature of approximately 800° C., gets connected via a heat pipeline to the CO₂ regenerating stream heater 9 and further to the waste heat boiler 4. The second stream of excess CO₂ at a temperature of approximately 400° C. flows through the CO₂ pipeline 10b to the heat exchanger 4a in the waste heat boiler heat 4 and, cooled down in the boiler, is discharged by CO₂ pipeline 10f for utilisation. The cooled eco-methane stream flows through the pipeline 20d to the power generation unit 5, said unit having a connection to a power grid 6, where it feeds the fuel cell 45 and a gas-steam power and heat plant. Hot flue gases from the fuel cell flow in pipelines 7e through the collector pipeline 7f to the waste heat boiler 4. The fuel cell also comprises a heat exchanger 8a connected to a heat exchanger in the collector heat exchanger 8 of the power generation unit 5. It also has a connection through an inverter to the power network 6. The cooled eco-methane stream also flows through the pipeline 20e into a combustion chamber 34 of a gas turbine unit that consists of a first gas turbine 36 connected via a shaft to a first generator 36a and to an air compressor 35, said first generator 36a having a connection to the power grid 6. The air compressor 35 delivers air to the combustion chamber 34 through a pipeline 42. The hot and compressed flue gases at a temperature of approx. 1200° C. leave the chamber 34 and flow to the first gas turbine 36 where they expand and partially cool down to a temperature of approximately 700° C. in the last stage of the turbine and the flue gases flow through the blowout flue gas pipeline 43 to the heat exchanger 8b located in the collector heat exchanger 8 and further are sent to the waste heat boiler 4. The expanded flue gases leaving the first turbine 36 are sent through a flue gas pipeline 7g directly to the waste heat boiler 4. The waste heat boiler 4 produces process steam at about 400° C., said steam being sent through steam pipeline 1a to the third reactor 3, and power steam at 585° C. sent through steam pipeline 11b to a second steam turbine 38 coupled through a shaft to a second generator 38a, said generator having a connection to the power grid 6. The steam turbine 38 is connected by a cooled down steam pipeline to a condensing unit 39, from which the resulting condensate flows through a condensate pipeline 40 to a condensate pump 41 and are pumped to the waste heat boiler 4.

### Example II

Bio-carbon with elemental carbon content C′ of 77% was fed using bio-hydrogen to the bio-carbon hydrogasification process. In the first bio-carbon hydrogasification reactor shown in FIG. 2, a complete gasification of the bio-carbon is carried out. The power generation unit is presented in FIG. 4. It is a fuel cell being a part separated from the system shown in FIG. 4. Dry straw was used as the biomass subjected to the full pyrolysis to bio-carbon process at a temperature of about 300° C., producing about 350 kg of bio-carbon per 1 tonne of dry straw plus pyrolytic gas. Dry straw is entered using a biomass conveyor 21 to a biomass pyrolysis apparatus 22, then the bio-carbon produced is fed to a bio-carbon preparation unit 25 where it is appropriately comminuted, and a part of the pyrolytic gas is fed via a pipeline 22a to a gas burner 22c in the apparatus 22, and the other part of the pyrolytic gas is fed via a pipeline 22b to a gas burner 9b in the regenerating CO₂ stream preheater 9. Appropriately comminuted in the bio-carbon preparation unit 25, bio-carbon is fed via a bio-carbon conveyor 26 at the top of the first bio-carbon hydrogasification reactor 1 where it undergoes complete hydrogasification to bio-methane using bio-hydrogen at a temperature of approx. 815° C. according to a method provided in Example I. From the first reactor 1, raw gas is fed via a pipeline 16 to a gas and vapour separator 15. The composition of the raw biogas is given in Example I. In the vapour and gas separator 15, the raw gas is desulphurised and separated, preferably on a membrane through which only hydrogen flows, in a known way, recycled via pipeline 19 to the bio-hydrogen pipeline 18a, whereas the bio-methane stream introduced to the pipeline 20 is split into two equal streams—a hot bio-methane stream supplied through a pipeline 20a to the third bio-hydrogen production reactor 3, and a stream of bio-methane cooled down in the heat exchanger 7c, supplied through a pipeline 20d to feed the power generation unit 5 in the form of a fuel cell 45. Surplus bio-methane is supplied through pipeline 20c to a compressor which compresses bio-methane in a compressed bio-methane tank. The production of bio-hydrogen in the third reactor 3 is carried out as shown in Example I.

The operation of the waste heat boiler 4 producing only process steam at a temperature of approximately 400° C. delivered through process steam pipeline 11a to the third bio-hydrogen production reactor 3, and partly through pipeline 11b for heating purposes, is carried out as described in Example I. The calcination of the spent CO₂ acceptor in the form of magnesium carbonate in the second reactor 2, using a hot stream of regenerating CO₂ supplied through CO₂ pipeline 10d to the heat exchanger 8 located in the fuel cell 45, where it is heated up to a temperature of about 600° C., and then fed to the heater 9 that heats this stream, where it is heated up by the gas burner 9b supplied with pyrolytic gas and partly with bio-methane to approximately 700° C., and then recycled via CO₂ pipeline 10 to the second MgCO₃ calcination reactor 2, is carried out as described in Example I.

The bio-methane stream, cooled down in the heat exchanger 7c, flows to the power generation unit 5 where it feeds the fuel cell 45. Hot flue gases from the fuel cell flow through pipelines 7e and further through collector pipeline 7f to the waste heat boiler 4 where they pass heat, and then are discharged to the atmosphere. The fuel cell also comprises a heat exchanger 8a, shown in FIG. 1 as the heat exchanger 8 in the power generation unit 5, connected to the preheater 9 of the regenerating CO₂ stream and further to the second MgCO₃ calcination reactor.

It also has a connection through an inverter to the power grid 6.

### Example III

Semi-carbon with elemental carbon content C′ of approx. 60% and lignite with elemental carbon content C of approx. 60% were fed to the bio-carbon and fossil carbon hydrogasification process, keeping the pre-set, preferred bio-carbon to coal ratio of C′:C=1:1. In the first bio-carbon and fossil carbon hydrogasification reactor 1 shown in FIG. 2 a partial gasification of the semi-carbon and lignite is carried out using bio-hydrogen, as a result of which raw gas is formed, being a mixture of unreacted hydrogen, bio-methane and eco-methane as well as other gaseous components, and also fine coke. The system for the production of bio-methane and eco-methane as well as electricity and thermal energy is depicted in FIG. 1, and the power generation unit is shown in FIG. 4. It is a gas-steam heat and power plant that is part of the power generation unit 5. Dry wood chips were used as the biomass for the partial pyrolysis process carried out in a biomass pyrolysis apparatus 22 at about 170° C.-270° C., fed into the apparatus 22 using a biomass conveyor 21. The product of the incomplete pyrolysis of biomass is semi-carbon as well as vapours and combustible pyrolytic gas, a part of which gas is supplied via a pipeline 22a to a gas burner 22c in the biomass pyrolysis apparatus 22 and the other part is supplied through a pipeline 22b to a gas burner 9b located in the preheater 9 of the regenerating CO₂ stream. The semi-carbon is conveyed from the biomass pyrolysis apparatus 22, using a bio-carbon conveyor 23, to a carbon mixture preparation unit 25, where it is mixed and appropriately cominuted together with lignite fed to the unit 25 through a coal conveyor 24. The carbon mixture formed is conveyed by conveyor 26 to an internal chamber 1c of the first reactor 1. The process of hydrogasification of the carbon mixture using bio-methane is carried out in a similar manner as in Example I. Raw gas flows through gas pipeline 16 into the vapour and gas separation vessel 15, in which unused hydrogen is separated from the methane mixture of bio-methane and eco-methane and is recycled by hydrogen pipeline 19 to bio-hydrogen pipeline 18a, and the methane mixture flows through the pipeline 20 which splits into a hot bio-methane pipeline supplying bio-methane to the third hydrogen production reactor 3 and into an eco-methane pipeline which supplies eco-methane to a heat exchanger 7c where it is cooled down and the heat obtained is sent via a heat pipeline to the waste heat boiler, whereas the cooled down eco-methane flows through gas pipeline 20d to the power generation unit 5, and surplus eco-methane flows through pipeline 20c to the gas distribution pipeline. Production of bio-hydrogen occurs in the third reactor 3 as a result of a reaction of bio-methane with water vapour and a CO₂ acceptor which is a mixture of magnesium oxide and calcium oxide in the ratio of 1:3. The energy needed for the endothermic reaction is brought about by hot bio-methane supplied to the third reactor 3 by pipeline 20a, hot steam supplied by steam pipeline 11a, and CO₂-uptake reactions of the CO₂ acceptor supplied to the third reactor 3 by CO₂ acceptor conveyor 13, whereas the amount of thermal energy supplied can be controlled, inter alia, by the selection of the CaO content in the mixture of magnesium oxide and calcium oxide. The reaction of bio-hydrogen production occurs at about 500° C. in the presence of a ceramic-supported nickel catalyst inside tubes 3a, which can be heated by a hot stream of CO₂ at a temperature of 750° C., flowing around these tubes especially in the start-up phase of the third reactor 3. The produced and cooled down bio-hydrogen is sent to the first carbon and bio-carbon hydrogasification reactor 1. The reaction of bio-hydrogen with elemental carbon C′ from the semi-carbon and with elemental carbon C from the lignite produces bio-methane and eco-methane and heat related to the carbon hydrogasification reaction. A part of that heat, from the cooling down of eco-methane in heat exchanger 7c is supplied by a heat pipeline to the waste heat boiler 4. Additionally, the waste heat boiler is supplied with heat from many sources: the power generation unit 5, flue gases from gas turbine via flue gas pipeline 7g, from cooling of bio-hydrogen in heat exchanger 7d, and from the CO₂ stream leaving the second spent CO₂ acceptor calcination reactor 2 via pipeline 10b to the heat exchanger 4a in the waste heat boiler 4 and leaving the waste heat boiler 4 via CO₂ pipeline 10c to a CO₂ sequestration facility. The waste heat boiler 4, which receives water from the condenser 39 from an external water source 12, produces process steam which is supplied by steam pipeline 11a to the third reactor 3 and power steam supplied by pipeline 11b to the second steam turbine 38 in the power generation unit 5. The spent CO₂ acceptor from the third reactor 3, in the form of magnesium and calcium carbonates, is fed at the top of the second carbonate calcination reactor 2 by spent CO₂ acceptor conveyor 14. Inside the second reactor 2, a descending bed of carbonates CaCO₃ and MgCO₃ fluidised by a hot stream of regenerating CO₂ at a temperature of about 950° C. undergoes thermal decomposition, with magnesium carbonate being decomposed in the upper part of this bed at about 630° C., and calcium carbonate decomposed in the lower part of this layer at a temperature of approximately 950° C. Regenerated CO₂ acceptor in the form of a mixture of magnesium and calcium oxides is supplied by CO₂ acceptor conveyor 13 to the third reactor 3, and carbon dioxide leaving the second reactor 2 through the CO₂ pipeline 10a at a temperature of approximately 400° C. is split into two streams: the first one is fed via CO₂ pipeline 10b to the heat exchanger 4a in the waste heat boiler 4 and so cooled flows through CO₂ pipeline 10c to a CO₂ sequestration process, especially based on silicates, e.g. serpentine silicate. Products of such fixation, magnesium carbonate, silica and water, are durable and easy to store. The second stream of CO₂, as a stream of regenerating CO₂, is sent by CO₂ pipeline 10d to heat exchanger 8 in the power generation unit 5 where it is heated up by a part of the exhaust gas at a temperature of approximately 700° C. that leaves the first gas turbine 36 to approximately 650° C., then the stream is directed to the preheater 9 where it is heated up to a temperature of about 1100° C. by a gas burner 9b operating on pyrolytic gas or by any other gaseous fuel, by pulverised fuel burner 27a operating on pulverised coke, and then that stream is sent via CO₂ pipeline 10 to a nozzle system 2b located at the bottom of the second reactor 2.

Cooled down eco-methane is sent via pipeline 20d to the power generation unit 5 being a gas-steam power and heat plant to combustion chamber 34 of the first gas turbine 36 in that unit. The process of generating electricity and heat has been shown in Example I.

In another embodiment of the invention, the preheater 9 of the regenerating CO₂ stream is connected to a solar collector system as shown in FIG. 5. The CO₂ stream, as a heat carrier, is sent from heat exchanger 30 via pipeline 31 to a spiral heat exchanger 33b located in the focus 33a of a concave mirror and is recycled by a heat carrier recycle pipeline to the preheater 9. In all such heat exchangers 33b of the solar collector system 33, CO₂ stream as the heat carrier is heated up to approx. 1200° C. and recycled back to a heat exchanger 30 located in the preheater 9 from which heat is supplied through CO₂ pipeline 10 to the second spent CO₂ acceptor calcination reactor 2. In this embodiment of the present invention it is preferred to use only calcium oxide as the CO₂ acceptor, which is sent to the third bio-hydrogen production reactor 3, and the spent CO₂ acceptor in the form of calcium carbonate is recycled back to the second reactor 2. Molar heat of thermal decomposition of CaCO₃ to CaO and CO₂, amounting to 178.8 kJ/mol, is high and represents 45.5% of the heat of combustion of 1 mole of elemental carbon C from lignite—amounting to 393.5 kJ/mol. This heat, with high efficiency up to 80%, is passed by chemical energy of the CO₂ acceptor to the chemical energy of the gas fuel that supplies the gas-steam power and heat plant, and that plant generates power with high efficiency of around 60%. Therefore, the efficiency of converting solar energy into electric energy in this system is approximately 48%, whereas the efficiency of currently used photovoltaic cells is approximately 15%. In addition, thermochemical energy is accumulated in calcium oxide and in the manufactured gas fuel, which substances can be stored, and their storage method depends on the annual sunshine time.

### Example of the Device

As shown in FIG. 1, the system consists of a first carbon and/or bio-carbon hydrogasification reactor 1, a second carbonate calcination reactor 2, and a third reactor 3 for the production of bio-hydrogen, a waste heat boiler 4, a power generation unit 5 connected to a power grid 6, heat transfer pipelines 7a and 7b, a collector heat exchanger 8 in the power generation unit, a preheater 9 for the regenerating CO₂ stream, CO₂ gas pipelines 10 (a, b, c, d, e, f), steam pipelines 11a and 11b, a water pipeline 12, a conveyor 13 for CO₂ acceptor, a conveyor 14 for calcium and/or magnesium carbonates, a gas and steam separator 15, a raw gas pipeline 16, a pipeline 17 for dusts and residual gases, bio-hydrogen pipelines 18a and 18b, a hydrogen pipeline 19, a bio-methane pipeline 20a and eco-methane pipelines 20b and 20c, and a pyrolytic gas pipeline 22b, a bio-carbon conveyor 23, a fossil carbon conveyor 24, a carbon mixture preparation unit 25, a carbon mixture transporter 26, fine coke conveyors 28, 28a and 28b, or a carbon/bio-carbon conveyor 27, possibly a conveyor 28b to send ash to storage, a waste substance conveyor 29 and a heat exchanger 30 connected to a sub-system of solar collectors. The first carbon and bio-carbon hydrogasification reactor 1 is connected at the top by the carbon mixture conveyor 26 to the carbon mixture preparation unit 25 which has two connections: a connection to the lignite or coal conveyor 24 and a connection to the bio-carbon conveyor 23, said bio-carbon conveyor 23 being connected to the biomass hydrolysis apparatus 22. This apparatus has an inlet for dry biomass connected to the biomass conveyor 21; it also has an outlet for bio-carbon connected to the bio-carbon conveyor 23, as well as an outlet for combustible pyrolytic gases connected via pipeline 22a to a gas burner in the biomass pyrolysis apparatus 22 and via pipeline 22b to a gas burner in the regenerating CO₂ stream preheater 9. The first reactor 1 has at its bottom a bio-hydrogen inlet connected via the bio-hydrogen pipeline 18b and further through the heat exchanger 7d and hot bio-hydrogen pipeline 18a to the third bio-hydrogen production reactor 3, whereas pipeline 18a is connected through bio-hydrogen recycle pipeline 19 to vapour and gas separator 15. The first reactor 1 also has at its bottom an outlet for fine coke, connected using the fine coke conveyor 28 to the ground fine coke conveyor 28a and, via a coal pulveriser mill, to the pulverised fuel burner in the regenerating CO₂ stream preheater 9, whereas the coal pulveriser mill is also connected to the fossil carbon and bio-carbon conveyor 27 as well as, by fine coke conveyor 28b, the fine coke outlet is connected to the fine coke storage facility, and, in case of full conversion of fine coke with bio-hydrogen, that outlet becomes the ash outlet connected via conveyor 28b to an ash storage facility. The first reactor 1 also has a connection through the raw gas pipeline 16 to the vapour and gas separator 15, which has at its top a discharge 17 for dust, vapours and residual gases that have been removed from the raw gas. The vapour and gas separator 15 has at its bottom a hydrogen outlet connected through the hydrogen recycle pipeline 19 to the bio-hydrogen pipeline 18a, and it also has at its bottom an outlet connected to the methane mixture pipeline 20 which splits into hot bio-methane pipeline 20a connected to the third bio-hydrogen reactor 3 and the hot eco-methane pipeline 20b connected to a heat exchanger and, further, to the power generation unit 5. The eco-methane pipeline 20d also has a branch 20c to receive methane. The waste heat boiler 4 has a process steam discharge connected via steam pipeline 11a to the third bio-hydrogen production reactor 3, as well as a power steam discharge connected via pipeline 11b to a steam turbine in the power generation unit 5. The third bio-hydrogen production reactor 3 also has an inlet for the CO₂ acceptor, connected via CO₂ acceptor conveyor 13 to an outlet for the regenerated CO₂ acceptor at the bottom of the second spent CO₂ acceptor calcination reactor 2, and also the third reactor 3 has an outlet for spent CO₂ acceptor connected via spent acceptor conveyor 14 to a spent acceptor inlet at the top of the second spent acceptor calcination reactor 2. At the inlet of the second reactor 2, there is a CO₂ pipeline 10 connected to heat exchanger 9a located in the regenerating CO₂ stream preheater 9. The outlet for the CO₂ stream from the second reactor 2 is connected to the CO₂ pipeline 10a branching out into pipeline 10b connected to a heat exchanger in the waste heat boiler 4 and further CO₂ outlet. The waste heat boiler 4 has a connection via CO₂ pipeline 10c to a CO₂ sequestration subsystem and, via pipeline 10f, to CO₂ processing equipment. CO₂ pipeline 10d is connected to pipeline 10a and through the collector heat exchanger 8 located in the power generation unit 5 to heat exchanger 9a in the regenerating CO₂ stream preheater 9 equipped with a gas burner connected via pyrolytic gas pipeline 22b to pyrolytic gas pipeline 22a, as well as equipped with a pulverised coal burner connected through a carbon pulveriser mill to the fine coke conveyor 28a or the carbon/bio-carbon conveyor 27, and also equipped with heat exchanger 30 connected to a solar collector or a collector unit.

The power generation unit 5 has an electric connection 6 to a power grid, and a connection, via heat pipeline 7b to a municipal heat pipeline, as well as a connection via hot flue gas pipeline 7g to the waste heat boiler 4; additionally, the waste heat boiler 4 has a connection via water pipeline 12 to an external source of water.

FIG. 2 shows a schematic diagram of a sub-system for the production of bio-methane and eco-methane with the use of the first low pressure carbon hydrogasification reactor 1, vapour and gas separator 15, carbon feed preparation unit 25, biomass pyrolysis apparatus 22, heat exchanger 7d, as well as conveyors and pipelines. The first carbon and bio-carbon hydrogasification reactor 1 has a thermal shell 1d, internal reaction chamber 1c comprising a suspended falling carbon bed, said chamber connected through carbon feed inlet 1a to carbon feed conveyor 26. The chamber 1c has at its top an inlet 1h for the reactive gas, and at the bottom a connection to an external chamber 1b comprising a fluidised bed 1f of the carbon feed with fine coke. Raw gas outlet is connected via a pipeline 16 to the vapour and gas separator 15. In addition to that, chamber 1c has a bio-hydrogen inlet 1g connected via cooled down bio-hydrogen pipeline 18b to heat exchanger 7d and further by hot bio-hydrogen pipeline 18a to the third bio-hydrogen production reactor 3, and it also has a fine coke outlet 1e connected to fine coke conveyor 28 which is connected to ground fine coke conveyor 28a and the conveyor 28b that sends the fine coke to storage, and, in case of full conversion of the carbon feed with bio-hydrogen, this will be ash outlet 1e connected to conveyor 28b sending the ash to storage. The heat exchanger 7d is connected via a heat pipeline to the waste heat boiler, and bio-hydrogen pipeline 18a is connected by the hydrogen recycle pipeline 19 to the hydrogen outlet at the vapour and gas separator 15. This separator also has an outlet for the bio-methane and eco-methane mixture connected to the mixture pipeline 20 and a discharge for dust, vapours and residual gases connected to pipeline 17. The first carbon and bio-carbon hydrogasification reactor 1 is connected at the top by carbon mixture feed conveyor 26 to the carbon feed preparation unit 25 which is connected to coal conveyor 24 and, by bio-carbon conveyor 23, to the biomass pyrolysis apparatus 22. The apparatus 22 has a connection to dry biomass conveyor 21 and is connected by the pyrolytic gas pipeline 22a to the gas burner 22c located in that apparatus and a connection of that pipeline by pipeline 22b to the gas burner located in the regenerating CO₂ stream preheater.

FIG. 3 depicts a schematic drawing of ties between the second reactor 2 for the calcination of magnesium carbonate or a mixture of magnesium and calcium carbonates with the waste heat boiler 4 and the third reactor 3 for the production of bio-hydrogen as well as the power generation unit 5 and the regenerating CO₂ stream preheater 9.

The second reactor 2 for the calcination of magnesium carbonate or a mixture of magnesium and calcium carbonates is preferably built in the shape of a shaft furnace; it consists of a thermally insulated shell having at its top an inlet for spent CO₂ acceptor, connected via spent CO₂ acceptor conveyor 14 to the spent acceptor outlet at the third bio-hydrogen production reactor 3, and having at the bottom an outlet for regenerated CO₂ acceptor in the form of magnesium oxide or a mixture of magnesium and calcium oxides, said outlet connected to a CO₂ acceptor feeder 2a and further, via acceptor conveyor 13, to the CO₂ acceptor inlet at the third reactor 3. The second reactor 2 has at its bottom a CO₂ nozzle system 2b that feeds hot regenerating CO₂ stream at a temperature of approx. 650° C.-700° C. in case of thermal decomposition of MgCO₃ in the fluidised bed or approx. 1000° C.-1100° C. in the case of thermal decomposition of a mixture of carbonates MgCO₃ and CaCO₃ in the fluidised bed, and at the top it has a CO₂ outlet connected to CO₂ pipeline 10a splitting into two branches: into a branch 10b of the CO₂ pipeline connected to heat exchanger 4a located in the waste heat boiler 4 and, on leaving the waste heat boiler, splitting into CO₂ pipeline 10c leading to the CO₂ sequestration sub-system and pipeline 10f, and into a branch 10d of the regenerating CO₂ stream pipeline connected to the collector heat exchanger 8 located in the power generation unit 5 and further connected to the heat exchanger 9a in the regenerating CO₂ stream preheater 9 and further, through a CO₂ pipeline 10 it is connected to a nozzle system 2b. The regenerating CO₂ stream preheater 9 additionally has a gas burner 9b connected to pyrolytic gas pipeline 22b, a pulverised coal burner 27a with a fine coke/coal pulveriser mill connected to ground fine coke conveyor 28a and to coal/bio-coal conveyor 27, whereas the ground coke conveyor 28a has a connection to the fine coke conveyor 28 which also has a connection to fine coke conveyor 28b discharging to a storage facility. The CO₂ preheater 9 also has an outlet for ash, connected to waste conveyor 29, and also has a heat exchanger 30 connected to the solar collector unit. The waste heat boiler 4 has a collective heat inlet 7a connected to a heat exchanger 7d for bio-hydrogen and a heat exchanger 7c for eco-methane. It also has an inlet for condensate and make-up water, connected to water pipeline 12, and an outlet for power steam connected via steam pipeline 11b to a steam turbine in the power generation unit 5, and a process steam outlet connected via steam pipeline 11a to the third reactor 3. The hot CO₂ stream pipeline 10 has a connection in the form of C02 pipeline 10e to the third reactor 3.

The third bio-hydrogen production reactor 3 is built inside with tubes 3a with catalyst inside them, has a bio-hydrogen outlet connected through hot bio-hydrogen pipeline 18a to heat exchanger 7d and to pipeline 19 for recycled hydrogen from the vapour-gas separator. The heat exchanger 7d is connected via a pipeline to the waste heat boiler 4, and also, via cooled down bio-hydrogen pipeline 18b, to the first carbon hydrogasification reactor. The hot bio-methane inlet at the third reactor 3 is connected through bio-methane pipeline 20a to methane mixture pipeline 20 coming from the vapour-gas separator 15, which is also connected to eco-methane pipeline 20b connected to heat exchanger 7c and further connected through pipeline 20c and pipeline 20d to the power generation unit 5. That unit also has a connection 6 to a power grid.

FIG. 4 depicts a power generation unit 5 that consists of a high-temperature fuel cell 45 and a gas-steam power and heat plant which basically consists of a first gas turbine 36 coupled via shaft with a first generator 36a, a second steam turbine 38 connected via shaft with a second generator 38a, and a waste heat boiler 4. Hot eco-methane pipeline 20b connected through heat exchanger 7c to cooled down eco-methane pipeline 20d which branches out into three branches: the first branch in the form of eco-methane pipeline 20e is connected to the combustion chamber 34 of the gas turbine unit, the second branch on the form of eco-methane pipeline 20f is connected to the fuel cell 45, and the third branch 20c. Heat exchanger 7c is connected by a heat pipeline to the waste heat boiler 4.

The fuel cell 45 is connected to an air pipeline 44, and the pipelines 7e for flue gases exiting the fuel cell 45 are connected through collector pipeline 7f to a heat exchanger in the waste heat boiler 4. The heat exchanger 8a located in the fuel cell 45 is connected to the collector heat exchanger 8 through pipeline 10d with regenerating CO₂ stream preheater. The electricity outlet at the fuel cell 45 is connected by an inverter to a power grid 6.

The combustion chamber 34 is connected at the inlet, by air pipeline 37, to an air compressor 35 coupled via shaft with the first gas turbine 36 and a start-up engine 35a, and at its exit the combustion chamber 34 is connected by hot flue gas pipeline 42 to the first gas turbine 36 coupled via shaft with the first generator 36a connected to the power grid 6, whereas the exit of the discharge flue gases from the turbine is connected by flue gas pipeline 43 to the heat exchanger 8b located in the collector heat exchanger 8 of the power generation unit 5 and further connected to the waste heat boiler 4, and the outlet of the expanded flue gas from the first turbine 36 is connected via flue gas pipeline 7g to the waste heat boiler 4 which has a discharge outlet 43a for cooled down flue gas and an inlet of the collector heat pipeline 7a. In addition, the waste heat boiler 4 has a hot CO₂ stream inlet through CO₂ pipeline 10b and an outlet of that pipeline branching out into CO₂ pipeline 10c connected to the CO₂ sequestration sub-system and CO₂ pipeline 10f connected to CO₂ pipeline 10g.

The waste heat boiler 4 also has a process steam outlet connected via steam pipeline 11a to the third bio-hydrogen production reactor, as well as a power steam discharge outlet connected through steam pipeline 11b to the second steam turbine 38, and the outlet at the second turbine 38 is connected to a condenser 39 which, in turn, via condensate pipeline 40 through condensate pump 41, is connected to the waste heat boiler 4. The waste heat boiler 4 also has a connection to an external water source through water pipeline 12.

FIG. 5 shows a solar collector unit coupled with the regenerating CO₂ stream preheater. The regenerating CO₂ stream preheater 9 is equipped with an incoming CO₂ stream pipeline 10d connected to the heat exchanger 9a and further through the regenerating CO₂ stream pipeline 10 connected to the second spent CO₂ acceptor calcination reactor. It is also equipped with a gas burner 9b connected to the pyrolytic gas pipeline 22b and a pulverised coal burner 27a with a pulveriser mill connected to the ground fine coke conveyor 28a and/or the coal/bio-carbon conveyor 27. Additionally, the preheater 9 is equipped with a heat exchanger 30 which at the outlet is connected via heat carrier pipeline 31 to the heat exchanger 33b located in the focus 33a of concave mirrors in the solar collector unit 33 and further through heat carrier pipeline 32 it is connected to the heat exchanger 30 located inside the preheater 9.

1. A method for the manufacture of bio-methane and eco-methane as well as electricity and thermal energy using a process of pyrolysing biomass to biocarbon mixed with comminuted and, possibly, appropriately prepared fossil carbon and using a process of hydrogasification of the carbon mixture to raw gas, its desulphurisation and separation into hydrogen and methane using a process of producing hydrogen in a reaction of methane with steam and with a CO₂ acceptor and regeneration of the acceptor and with the use of an MCFC-type fuel cell and a gas-steam power and heat plant to produce electricity and heat, characterized in that a comminuted dry plant-based material or a waste material is subjected, individually or in specified sets, to a pyrolysis process, either in the temperature range of approximately 170° C.-270° C. at normal pressure to produce semi-carbon and a pyrolytic gas, or in the temperature range of approximately 270° C.-300° C. to produce bio-carbon and a pyrolytic gas, or in the temperature range higher than 300° C., with a part of the pyrolytic gas directed to carry out pyrolysis of biomass in a biomass pyrolysis apparatus, and the other part of pyrolytic gas is directed to pre-heat the regenerating stream of CO₂ in the preheater, whereas the semi-carbon obtained, containing approx. 60%-65% of elemental carbon is mixed preferably with comminuted lignite, while the bio-carbon containing approx. 65%-80% of elemental carbon is mixed with comminuted coal at a ratio of bio-carbon based elemental carbon C to fossil carbon-based elemental carbon preferably being C:C=1:1 and that mixture is fed to a first low- or high pressure carbon hydrogasification reactor where a full hydrogasification process is carried out using bio-hydrogen to produce raw gas and ash, or an incomplete carbon and bio-carbon hydrogasification process is carried out to produce raw gas and fine coke, said fine coke being partly discharged to a fine coke storage site and partly sent to preheat a regenerating CO₂ stream in the preheater and burned, and the raw gas obtained is supplied to a vapour and gas separation process where it is dried and subjected to desulphurisation, followed by separation into hydrogen, residual gases and a methane mixture composed of pure bio-methane and eco-methane, whereas a part of the methane after cooling down in a heat exchanger is sent to feed a power generation unit from which heat is supplied to a heat exchanger to heat the CO₂ regenerating stream and to a heat exchanger in a waste heat boiler that produces process steam and power steam, and the other part of the cooled down methane is sent either to a compressor or to a condenser or enters a gas distribution pipeline, whereas hot bio-methane at a temperature approx. 800° C. enters a third bio-hydrogen production reactor where, in a reaction between bio-methane and hot steam supplied from the waste heat boiler and with a CO₂ acceptor, bio-hydrogen is produced and after cooling down is sent to the process of hydro gasification of a carbon mixture in the first reactor, whereas used CO₂ acceptor in the form of magnesium and calcium carbonates is sent to the second reactor for a calcination process using a hot stream of regenerating CO₂, after which the regenerated CO₂ acceptor in the form of magnesium oxide and calcium oxide enters the third reactor, and the CO₂ stream at a temperature of approx. 400° C. leaving the second reactor is supplied in a first part to a heat exchanger in the waste heat boiler where it is cooled down and sent to either a known CO₂ sequestration process or to compression and solidification of CO₂ to dry ice, or is discharged to atmosphere, and in a second part as the regenerating CO₂ stream it is heated up to a temperature of approx. 700° C. required for the calcination of magnesium carbonate or up to a temperature of 1000° C.-1100° C. required for the calcination of a mixture of magnesium and calcium carbonates, as well as in a preheater periodically supplied with hot heat carrier heated in a solar collector up to a temperature of 1 100° C.-1200° C. and the regenerating CO₂ stream so heated is fed to the second reactor.

2. The method according to claim 1, characterised in that the comminuted dry mixture of semi-carbon with lignite or bio-carbon with coal, after removing air from it using CO₂, is supplied from the carbon mixture preparation unit to the first low pressure reactor where a process of hydrogasification of the carbon mixture is carried out first in an internal chamber in a suspended bed descending co-currently with a gas fed at the top of the internal chamber, said gas containing approx. 50% H2 and 50% CH4 at a temperature of approx. 815° C. at standard pressure, and raw gas obtained in that process is sent from the first reactor to a separator of vapours and gases where it is purified from dusts and admixed gases, and especially undergoes desulphurisation after which it is separated into a pure methane mixture consisting of bio-methane and eco-methane and into pure hydrogen which is recycled back to the bio-hydrogen stream, whereas the partly converted carbon mixture is sent to an external chamber of the first reactor, where it is subjected to full conversion with hydrogen to ash and a hydrogen-plus-methane gas, or subjected to partial conversion to fine coke and hydrogen-plus-methane gas, the ash being discharged to a storage site and the fine coke being sent to either combustion or storage, while the hydrogen-plus-methane gas is fed at the top of the internal chamber of the reactor.

3. The method according to claim 1, characterised in that in the first high pressure reactor a carbon mixture after combining it with mineral oil is fed in the form of a suspension, using a spray nozzle, to a topmost section of the reactor, called the evaporation section, at a pressure of approx. 6.8 MPa and prevailing temperature approx. 315° C., the oil is evaporated and its vapours are discharged along with hot raw gas leaving a middle section called the first stage of carbon hydrogasification to a vapour-gas separator where the mineral oil, recovered and subsequently condensed in a condenser, is recycled back to the carbon-in-oil suspension preparation unit, and purified raw gas, especially desulphurised, is separated into a methane mixture and pure hydrogen combined with bio-hydrogen, whereas dry carbon and bio-carbon particles at a temperature of approx. 300° C. are sent to the middle section and subjected to fluidisation in a stream of biohydrogen-containing gas leaving a bottom section of the reaction, called the second stage of carbon hydrogasification, and in the middle section at a temperature raised to approx. 650° C. and pressure of 6.0 MPa there occurs degassing and partial hydrogasification of carbon particles, arid next, the partially converted carbon mixture is subjected to full hydrogasification in a fluidised bed in the bottom section of the reactor at a temperature 750° C.-950° C. using bio-hydrogen fed to that section.

4. The method according to claim 1, characterised in that as the CO₂ acceptor that participates in the bio-hydrogen production process magnesium oxide is used, or, preferably, a mixture of magnesium oxide with calcium oxide at a preferred ratio MgO:CaO=₁)1:3 molar quantities of the substance, needed to supply to the reaction of bio-hydrogen formation an amount of heat around 155 kJ/mol—165 kJ/mol CH₄ at a temperature above 100° C. during continuous operation of the third reactor, depending, however, on the amount of heat brought into the reactor by these reactants; thus, this proportion is adjustable in the range of 1:10 to 10:1.

5. The method according to claim 1, characterised in that in the process of thermal decomposition of carbonates with the use of solar energy, the CO₂ acceptor that contributes energy to the bio-hydrogen production reaction is calcium oxide.

6. The method according to claim 4, characterised in that in the second shaft reactor in a bed of carbonates of magnesium and calcium fluidised by a hot stream of CO₂ at about 1100° C. in the lower zone of the reactor thermal decomposition of calcium carbonate is carried out in the temperature range around 1000° C.-800° C., and in the upper zone of the reactor thermal decomposition of magnesium carbonate is carried out in the range of approximately 800° C.-400° C. and oxides of magnesium and calcium and carbon dioxide are produced.

7. The method according to claim 1, characterised in that the power generation unit consumes eco-methane which is supplied to the gas turbine and a fuel cell, and the heat from the fuel cell, at a temperature of 650° C., is directed to a heat exchanger to preheat the regenerating CO₂ stream, and flue gas exiting the fuel cell at a temperature of approximately 400° C. is supplied to a heat exchanger in the waste heat boiler.

8. The method according to claim 1, characterised in that flue gases from the last stage of the gas turbine, at a temperature preferably about 700° C., are supplied to the heat exchanger to heat the regenerating CO₂ stream, and the flue gas exiting the outlet at a temperature of 400° C.-600° C. is fed to a heat exchanger in the waste heat boiler, wherefrom power steam at about 585° C. is fed to the steam turbine of a steam turbine unit.

9. The method according to claim 1, characterised in that the waste heat boiler receives heat from the power generation unit through flue gases at approx. 400° C.-600° C., the heat from the CO₂ stream leaving the second magnesium and/or calcium carbonates calcination reactor at approx. 400° C., the heat from the stream of hot bio-hydrogen at approx. 500° C. and from the stream of hot eco-methane at approx. 800° C. produced in the first carbon hydrogasification reactor.

10. The method according to claim 8, characterised in that the regenerating CO₂ stream preheater receives heat from a heat carrier heated up to approx. 1100-1200° C. by solar energy.

11. The method according to claim 10, characterised in that the heat carrier heated by solar energy is a gas which is inert with respect to the materials used in the solar concentrator unit, preferably carbon dioxide or nitrogen or argon, or a gas with high specific heat, preferably helium, or a vapour which is inert with respect to those materials, preferably water vapour or a liquid with a high boiling point.

12. The method according to claim 1, characterised in that the reactants: bio-methane, steam and CO₂ acceptor which produce bio-hydrogen in the presence of a Ni/Al₂O₃ nickel catalyst in the temperature range 500° C.-900° C. and at a pressure of 1.5 MPa-4.5 MPa in the first part of the third reactor in the reactor tubes are additionally heated by the hot CO₂ stream at a temperature of about 800° C.-1000° C.—especially during the start-up of the third reactor.

13. The method according to claim 1, characterised in that for the bio-hydrogen producing reaction in the third reactor, of carbon monoxide and water vapour with a mixture of gases flowing in from the first part to the second part of that reactor, operating in a lower temperature range than the first part, either a Cu—Zn/Al₂O₃ catalyst is used in the range of approximately 200° C.-300° C. or an Fe/Al₂O₃ catalyst in the higher temperature range of 350° C.-500° C. followed by a Cu/Al₂O₃ catalyst in the range of approx. 200° C.-300° C.

14. A system for the manufacture of bio-methane and eco-m ethane as well as electric and thermal energy, consisting of a carbon hydrogasification reactor, a magnesium and calcium carbonates calcination reactor, a bio-hydrogen production reactor, a vapour and gas separator, a biomass pyrolysis apparatus, a carbon feed mixture preparation unit, a waste heat boiler possibly connected to a CO₂ sequestration sub-system, a power generation unit, a regenerating CO₂ stream preheater, heat exchangers, conveyors, pumps and pipelines for liquids, vapours and gases, characterised in that a first carbon hydrogasification reactor having an inlet connected via a carbon mixture or slurry conveyor to a carbon mixture/slurry preparation unit, which is connected to a biomass pyrolysis apparatus and a coal or lignite conveyor, and, also, the first reactor having a fine coke or ash outlet, and the outlet for the raw gas from the reactor has a connection to a vapour and gas separator which has a discharge outlet for dust, vapours and residual gases and an outlet for hydrogen in the form of a pipeline connected to a bio-hydrogen outlet from the third reactor in the form of a pipeline and connected to the first reactor, while the vapour and gas separator also has a bio-methane and eco-methane outlet in the form of a pipeline connected to the third bio-hydrogen production reactor and to the power generation unit, whereas the flue gas outlet at the power generation unit is connected via a pipeline to a waste heat boiler which has an outlet for process steam connected to the third reactor and an outlet for power steam connected to a steam turbine in the power generation unit as well as an inlet for CO₂ connected to a CO₂ outlet of the second reactor which additionally has an inlet for the regenerating CO₂ stream in the form of a pipeline connected to the preheater of that stream and an outlet for the CO₂ acceptor connected via a conveyor to the inlet of that acceptor at the third reactor and the outlet for the spent CO₂ acceptor at the reactor is connected via a conveyor to the second reactor.

15. The system according to claim 14, characterised in that the biomass pyrolysis apparatus has an inlet for dry biomass connected to a biomass conveyor and an outlet for bio-carbon connected to a bio-carbon conveyor to the unit, as well as an outlet for combustible pyrolytic gases connected to a gas burner in the biomass pyrolysis apparatus and to a gas burner in the regenerating CO₂ stream preheater.

16. The system according to claim 14, characterised in that the first low pressure reactor comprises two chambers: an internal chamber and an external chamber, and a thermally insulated shell through which passes an inlet channel for a feed carbon mixture from the mixture preparation unit having a CO₂ inlet connected to a CO₂ pipeline tied with a CO₂ pipeline for processing and a gas outlet, whereas the internal chamber of the first reactor has inlets for the primary gas from the external chamber and a raw gas outlet and at the bottom an outlet for the partly converted carbon mixture to the external chamber which also has a hydrogen inlet.

17. The system according to claim 14, characterised in that the second reactor having a shape of a shaft furnace has at its bottom a CO₂ acceptor feeder, said feeder connected via acceptor conveyor to acceptor inlet at the third reactor having an outlet for used CO₂ acceptor connected via a conveyor to an inlet at the second reactor which is equipped with at least one nozzle for the regenerating CO₂ stream, said nozzle located at the bottom and connected to the regenerating CO₂ stream preheater, and in addition, the second reactor has at its top an outlet for CO₂ connected to the CO₂ inlet of the waste heat boiler.

18. The system according to claim 14, characterised in that the CO₂ preheater is equipped with a heat exchanger, which is connected to a heat exchanger situated in the power generation unit and is equipped with a gas burner connected to the pyrolytic gas pipeline and a pulverised fuel burner, connected to a fine coke conveyor and/or a coal or bio-carbon conveyor, and beside that, the preheater has a heat exchanger connected to a solar collector unit through a heat carrier outlet to a heat exchanger located in the focus of each concave mirror and through an inlet of this carrier, while the heat exchanger in the power generation unit has at the inlet a connection to a regenerating CO₂ stream pipeline and at the exit a connection to the heat exchanger in the preheater, while the regenerating CO₂ stream outlet from the heater is connected to the inlet of the second reactor: to a nozzle or a nozzle system, placed in the bottom of the reactor, and also the regenerating CO₂ stream outlet has a connection to the third reactor and the power generation unit producing heat and electricity has an electrical connection to a power network, as well as a connection via a heat pipeline to a heat distribution network.

19. The system according to claim 14, characterised in that the power generation unit consisting of a fuel cell and a steam & gas heat & power plant, is connected to a collector heat exchanger, whereas the fuel cell has a heat exchanger connected via a heat pipeline to the collector heat exchanger, and the fuel cell flue gas outlet is connected by a pipeline to the waste heat boiler, while the flue gas outlet at the methane combustion chamber is connected to a gas turbine and the turbine flue gas outlet is connected to the heat exchanger located in the collector heat exchanger and further to the waste heat boiler, which is connected to the third reactor through a process steam pipeline and to a steam turbine by a steam power pipeline, and additionally through the heat exchanger a CO₂ pipeline passes with a heat exchanger connected to the heat exchanger in the preheater.

20. The system according to claim 14, characterised in that the waste heat boiler has an inlet for water and an inlet for CO₂ from the second reactor, said inlets connected through a heat exchanger in the boiler to a CO₂ outlet for processing, including, through an outlet to the unit or to the atmosphere and/or with an outlet for CO₂ sequestration and, additionally, the waste heat boiler has an inlet for the heat carrier from the hydrogen, methane and fuel cell flue gas cooling process.

21. The system according to claim 14, characterised in that the third reactor has internal tubes containing a nickel catalyst supported on a ceramic substrate Ni/Al₂O₃ located in the first part of the third reactor, said first part connected to an inlet for hot CO₂ stream, as well as tubes containing either a Cu—Zn/Al₂O₃ catalyst or an Fe/Al₂O₃ and Cu/Al₂O₃ catalyst, said tubes located in the second part of the third reactor, while the third reactor has an inlet for bio-methane, an inlet for process steam and an inlet for the CO₂ acceptor, as well as an outlet for magnesium and calcium carbonates and an outlet for bio-hydrogen.

22. The system according to claim 19, characterised in that the power generation unit for small objects consists of either a fuel cell and/or a co-generator.

23. The system according to claim 19, characterised in that the methane pipeline that supplies the power generation unit has a connection in the form of a pipeline to either a gas distribution pipeline or a methane compressor and a CNG tank or a methane condenser and an LNG tank.
